(19) United States
(12) Patent Application Publication
(10) Pub. No.: US 2005/0084048 A1
(43) Pub. Date: Apr. 21, 2005

(54) CLOCK AND DATA RECOVERY CIRCUIT

(76) Inventor: Ching-Yen Wu, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,490

(22) Filed: Jul. 15, 2004

(30) Foreign Application Priority Data
Oct. 15, 2003 (TW) 092128617

(51) Int. Cl. H04L 7/00

(52) U.S. Cl. 375/355; 375/371

(57) ABSTRACT

A clock and data recovery circuit generates a recovery and a reference clock corresponding to the input data and includes a phase shifter generating M discrete clocks at different phases, a data sampler generating a select signal according to the input data and the M discrete clocks, a primary phase selector outputting two consecutive discrete clocks and at least one interpolated clock with a phase between the phases of the two consecutive discrete clocks, a multiplexer selecting one of the two consecutive discrete clocks or the interpolated clock as a selected output clock, a phase detector receiving the selected output clock as the recovery clock and outputting an advanced calibration signal if the recovery clock leads or lags the input data, an advanced phase selector receiving the advanced calibration signal and transmitting the phase select signal to the multiplexer for adjusting the selected output clock and a primary calibration signal.

### BACKGROUND OF INVENTION

1. Field of the Invention

The present invention relates to serial data communications, and more specifically, to a clock and data recovery circuit (CDR) used in a serial data communication system.

2. Description of the Prior Art

Compared with parallel data communications, serial data communications are small in size and have a longer transmission distances. Although slower than parallel data communications, recently developed serial data communication devices such as USB1.1 and USB2.0 have solved those disadvantages, wherein the transmission speed of USB1.1 is up to 12 Mbps, and USB2.0 up to 480 Mbps.

Please refer to FIG. 1 showing a conventional serial data communication system. The serial data communication system 10 includes a transmitter 12 for transmitting data, a serial bus 14 connected to the transmitter 12 for transmitting data, and a receiver 16 for receiving data from the serial bus 14. Please refer to FIG. 2 showing a waveform diagram concerning the output data DATAₒᵤₜ transmitted by the transmitter 12 and input data DATAᵢₙ received by the receiver 16 in the serial data communication system 10. As shown in FIG. 2, the input data DATAᵢₙ received by the receiver 16 is not synchronized with the output data DATAₒᵤₜ transmitted by the transmitter 12. In other words, the phases of the input data DATAᵢₙ and the output data DATAₒᵤₜ are different. Therefore, the receiver 16 needs to include a CDR 20 to adjust the phase difference between the input data DATAᵢₙ and the output data DATAₒᵤₜ, in order to correctly read the input data DATAᵢₙ.

The receiver 16 shown in FIG. 1 includes a front amplifier 18 for signal amplifying, and the CDR 20. The CDR 20 can be a hybrid CDR combining the advantages of high data transmission speed analog CDR and low noise interference digital CDR. The CDR 20 generates corresponding recovery data DATA_{rd} and a re-time clock CLKᵣₜ according to the input data DATAᵢₙ. The CDR 20 includes a phase shifter 22 for generating a plurality of discrete clocks CLK_{dis} at different phases according to a reference clock CLK_{ref} (e.g. the phase shifter 22 generates 24 discrete clocks CLK₀-CLK₃₄₅ at different phases. In other words, any two consecutive discrete clocks CLK_{dis} have a phase difference of 15 degrees.). A counter 24 is used for counting the number of rising edges from “0” to “1” to determine whether to start sampling, a data sampler 26 for receiving the 24 discrete clocks CLK₀-CLK₃₄₅ and the input data DATAᵢₙ and outputting a select signal CS accordingly (the select signal CS indicates the period when between two consecutive discrete clocks CLK_{dis} among the 24 discrete clocks CLK₀-CLK₃₄₅ the rising edge of the input data DATAᵢₙ occurs). A phase selector 28 is electrically connected to the data sampler 26, a multiplexer 30 is used for selecting one from the 24 discrete clocks CLK₀-CLK₃₄₅ according to a phase select signal PS output by the phase selector 28, and a phase detector 32 is for modifying the phase select signal PS output by the phase selector 28 according to the phase difference between a selected clock CLK_{cs} output by the multiplexer 30 and the input data DATAᵢₙ. The frequency of the reference clock CLK_{ref} of the phase shifter 22 is approximately the same as that of the output data DATAₒᵤₜ transmitted by the transmitter 12.

Please refer to FIG. 3 showing a circuit diagram of the data sampler 26 in the CDR 20. The data sampler 26 includes 24 D flip-flops 34 with all their clock input ends CLK electrically connected to the input data DATAᵢₙ, and their signal input ends D respectively electrically connected to the discrete clocks CLK₀-CLK₃₄₅ generated by the phase shifter 22. A signal output end Q of the D flip-flop 34 shows that the rising edge of the input data DATAᵢₙ occurs between two consecutive discrete clocks among the 24 discrete clocks CLK₀-CLK₃₄₅. For instance, if the rising edge of the input data DATAᵢₙ occurs between discrete clocks CLK₁₃₅ and CLK₁₅₀, the select signal CS output by the data sampler 26 for this example is 003FFFx. This means the discrete clock CLK_{dis} selected by the multiplexer 30 is CLK₁₅₀ (or CLK₁₃₅).

The operation of the CDR 20 occurs after the number of the rising edges of the input data DATAᵢₙ counted by the counter 24 exceeds a predetermined value, i.e. under a stable condition and is described as follows. After detecting that the rising edge of the input data DATAᵢₙ occurs between the discrete clocks CLK₁₃₅ and CLK₁₅₀, the data sampler 26 generates the select signal CS (003FFFx) corresponding to the discrete clock CLK₁₅₀. The phase selector 28 then generates the phase select signal PS according to the select signal CS and a calibration signal CR generated by the phase detector 32. This controls the multiplexer 30 to output one from the discrete clocks CLK₁₃₅, CLK₁₅₀, CLK₁₆₅ to be the selected clock CLK_{cs}. Eventually, the selected clock CLK_{cs} output from the multiplexer 30 becomes the re-time clock CLKᵣₜ, the result being that the re-time clock CLKᵣₜ triggers the input data DATAᵢₙ to form the recovery data DATA_{rd}.

During the transmission of the discrete clock CLK_{dis} generated by the phase shifter 22 toward the multiplexer 30, phase deviation is inevitable. Therefore, the selected clock CLK_{cs} output by the multiplexer 30 differs from an ideal discrete signal CLK_{ideal} corresponding to the input data DATAᵢₙ . Thus the selected clock CLK_{cs} output by the multiplexer 30 is not necessarily allow the recovery data DATA_{rd} corresponding to the input data DATAᵢₙ. The phase detector 32 is for further modifying the select signal CS output by the data sampler 26 according to the phase relationship between the selected clock CLK_{cs} and the input data DATAᵢₙ. This allows the phase selector 28 to generate the phase select signal PS in order to further control the multiplexer 30 to output the selected clock CLK_{cs} or a discrete clock CLK_{dis} previous or next to the selected clock CLK_{cs}. More clearly, if the phase detector 32 detects that the selected clock CLK_{cs} lags the input data DATAᵢₙ, the calibration signal CR generated by the phase detector 32 is accumulated on a following select signal CS generated by the data sampler 26 in order to form the phase select signal PS. For instance, if the discrete clock CLK₁₈₀ output by the multiplexer 30 (i.e. the selected clock CLK_{cs}) lags behind the input data DATAᵢₙ, the calibration signal CR generated by the phase detector 32 is accumulated on the select signal CS generated by the data sampler 26 in order to form the phase select signal PS. That is, the multiplexer 30 should originally output the discrete clock CLK₁₈₀ under control of a select signal CS generated by the data sampler 26 according to following input data DATAᵢₙ, however, due to the accumulation of the calibration signal CR, the multiplexer 30 outputs a discrete clock CLK₁₉₅ instead. Conversely, if the discrete clock CLK₁₈₀ output by the multiplexer 30 (i.e. the selected clock CLK_{cs}) leads the input data DATAᵢₙ, the calibration signal CR generated by the phase detector 32 is decreased from the select signal CS generated by the data sampler 26 in order to form the phase select signal PS. That is, the multiplexer 30 should originally output the discrete clock CLK₁₈₀ under control of a select signal CS generated by the data sampler 26 according to following input data DATAᵢₙ, however, due to the accumulation of the calibration signal CR, the multiplexer 30 outputs a discrete clock CLK₁₆₅ instead.

As for the CDR 20, the number of the discrete clocks CLK_{dis} generated by the phase shifter 22 directly relates to a phase jitter tolerable by the input data DATAᵢₙ. That is, the more discrete clocks CLK_{dis} generated by the phase shifter 22, the more synchronized the re-time clock CLKᵣₜ generated by the CDR 20 to the input data DATAᵢₙ. Accordingly, the more phase jitter the input data DATAᵢₙ can tolerate, the more accurate the recovery data DATA_{rd} is, and accordingly the lower bit error rate (BER) the recovery data DATA_{rd}. However, in order to read the input data DATAᵢₙ as accurately as possible, the data sampler 26 in the CDR 20 is required to include enough D flip-flops (or any implementation having phase delay circuits). These D flip-flops not only occupy too much area, but also consume too much power.

### SUMMARY OF INVENTION

It is therefore a primary objective of the present invention to provide a CDR to reduce the number of D flip-flops in a data sampler, in order to solve the problems mentioned above.

Briefly summarized, a clock and data recovery circuit (CDR) generates a recovery clock according to input data and a reference clock corresponding to the input data. The CDR includes a phase shifter generating M discrete clocks at different phases according to the reference clock; a data sampler generating a select signal according to the input data and the M discrete clocks; a primary phase selector outputting two consecutive discrete clocks and at least one interpolated clock with a phase between the phases of the two consecutive discrete clocks according to the select signal, a multiplexer selecting one from the two consecutive discrete clocks and the interpolated clock to be a selected output clock, a phase detector receiving the selected output clock to be the recovery clock, and outputting an advanced calibration signal if the recovery clock leads or lags behind the input data, an advanced phase selector receiving the advanced calibration signal and transmitting the phase select signal to the multiplexer for adjusting the selection of the selected clock, and a primary calibration signal to the primary phase selector for adjusting the two consecutive discrete clocks and at least one interpolated clock corresponding to them.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a conventional serial data communication system.

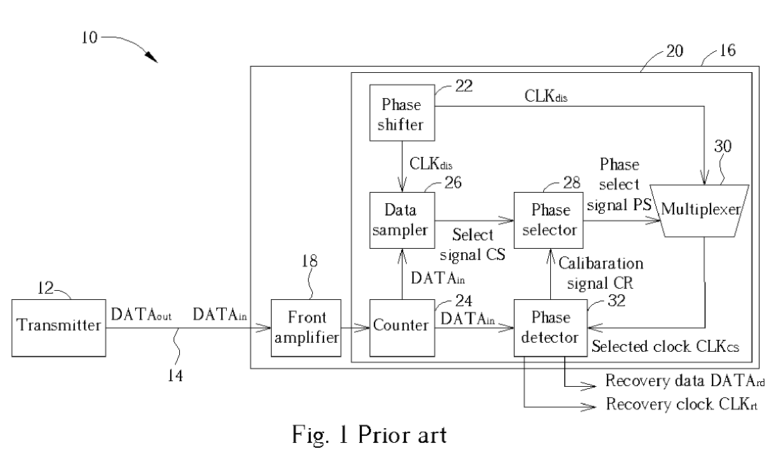

FIG. 2 is a waveform diagram concerning the output data transmitted by the transmitter and input data received by the receiver in the conventional serial data communication system.

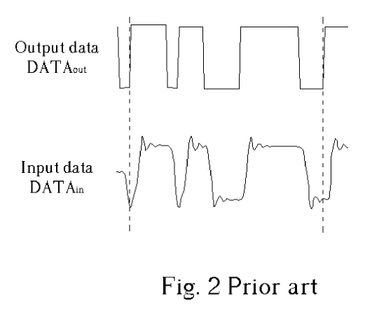

FIG. 3 is a circuit diagram of the data sampler in the conventional CDR.

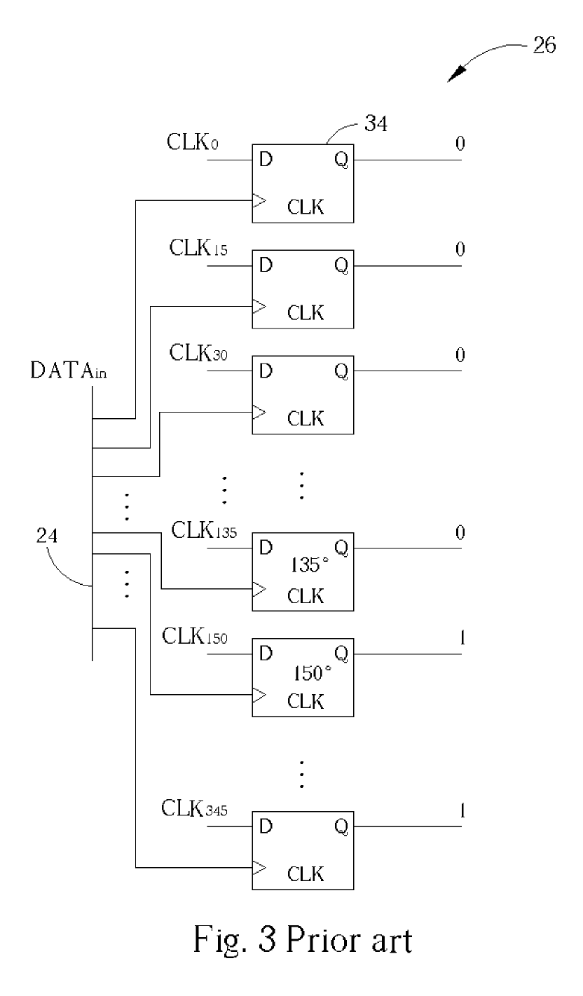

FIG. 4 is a block diagram of a CDR according to the present invention.

FIG. 5 is a circuit diagram of the data sampler in the CDR according to the present invention.

FIG. 6 illustrates the variation of the phase select signal according to the present invention.

FIG. 7 illustrates a circuit diagram of the primary phase selector in the CDR.

### DETAILED DESCRIPTION

A phase shifter in a CDR according to the present invention generates M discrete clocks CLK_{dis} wherein M is less than the number required by the prior art. At least one interpolated clock CLKᵢₙₜ is then found from any two consecutive discrete clocks CLK_{dis} by interpolation, and a set of clocks is formed by it and the two consecutive discrete clocks CLK_{dis}. Subsequently, one clock CLK_{cs} is selected being more synchronized to input data DATAᵢₙ from the set of clocks. Since finding at least one interpolated clock CLKᵢₙₜ by interpolation requires only one common circuit, a large number of D flip-flops as in the prior art are no longer required to implement the data sampler. So that the number of the D flip-flops, and accordingly the area occupied by the D flip-flops and the cost are effectively reduced.

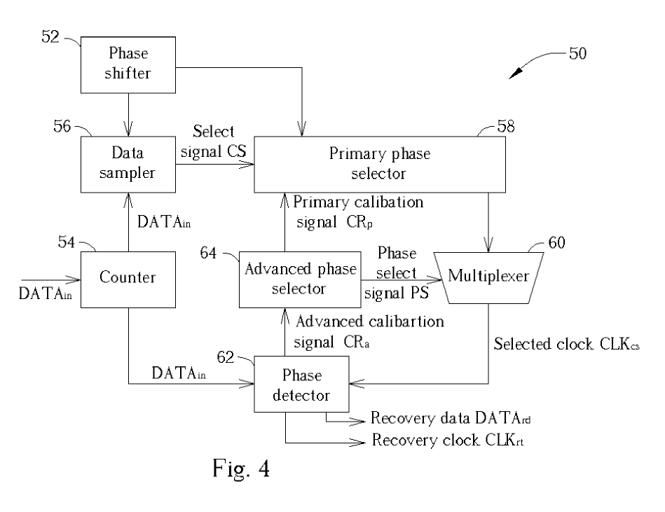

Please refer to FIG. 4 showing a block diagram of a CDR 50 according to the present invention. The CDR 50 includes a phase shifter 52, a data sampler 56 electrically connected to the phase shifter 52, a primary phase selector 58 electrically connected between the phase shifter 52 and the data sampler 56, a multiplexer 60 electrically connected to the primary phase selector 58, a phase detector 62 electrically connected to the multiplexer 60, a counter 54 electrically connected between the data sampler 56 and the phase detector 62, and an advanced phase selector 64 electrically connected to the multiplexer 60, the primary phase selector 58 and the phase detector 62.

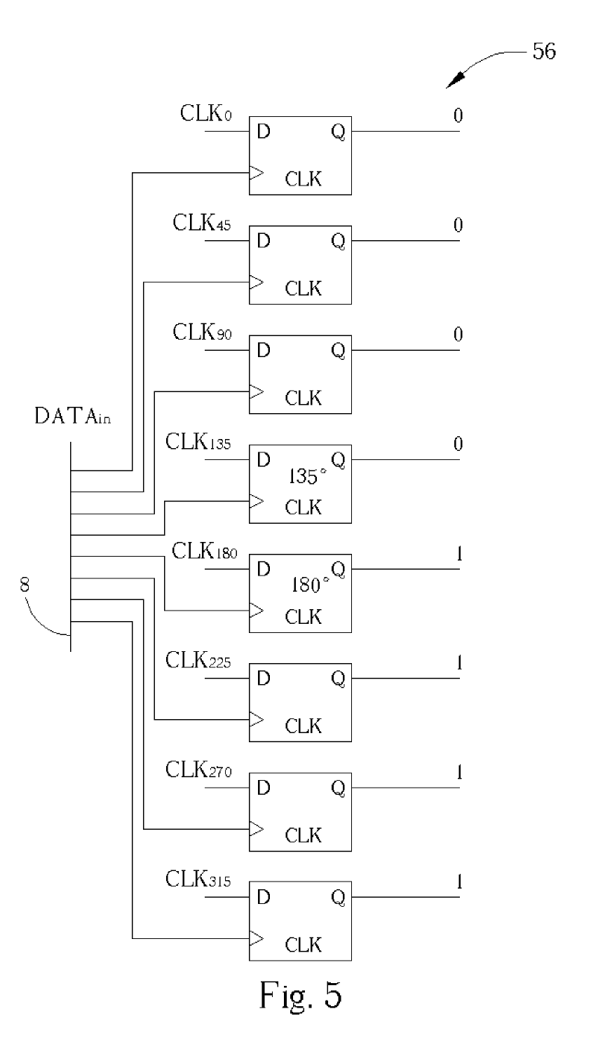

The phase shifter 52 is an analog phase-locked loop (APLL) or a delay-locked loop (DLL), which generates a plurality of discrete clocks CLK_{dis} at different phases according to a reference clock CLK_{ref}. In the present invention, since the discrete clocks are generated by interpolation, the phase shifter 52 is only required to generate 8 discrete clocks CLK₀ to CLK₃₁₅ at different phases. That is, any two consecutive discrete clocks CLK_{dis} have a phase difference of 45 degrees. The data sampler 56 generates a select signal CS according to where the rising edges of input data DATAᵢₙ occur. Please refer to FIG. 5 showing a circuit diagram of the data sampler 56 in the CDR 50 according to the present invention. The data sampler 56 is structurally similar to the data sampler 26 in the conventional CDR 20, however, the data sampler 56 samples the 8 discrete clocks CLK₀ to CLK₃₁₅ using the input data DATAᵢₙ to output the select signal CS. Because the multiplexer 60, the phase detector 62 and the counter 54 have the same functions as the multiplexer 30, the phase detector 32 and the counter 24 in the conventional CDR 20, a further description is hereby omitted.

The operation of the CDR 50 after the number of the rising edges of the input data DATAᵢₙ counted by the counter 54 exceeds a predetermined value is described as follows. (e.g. After a second and a third data, predetermined values of a primary calibration signal CRₚ and a phase select signal PS output from the advanced phase selector 64 have been set up as described in the following.) After detecting that the rising edge of the input data DATAᵢₙ occurs between discrete clocks CLK₁₃₅ and CLK₁₈₀, the data sampler 56 generates the select signal CS corresponding to the discrete clock CLK₁₈₀ (or CLK₁₃₅). The primary phase selector 58 then outputs the discrete clocks CLK₁₃₅ and CLK₁₈₀ (two consecutive discrete clocks CLK_{dis}) and discrete clocks CLK₁₅₀ and CLK₁₆₅ interpolated from the discrete clocks CLK₁₃₅ and CLK_{180.} (The existence of the discrete clocks CLK₁₅₀ and CLK₁₆₅ means that there is at least one interpolated clock CLKᵢₙₜ interpolated from the two consecutive discrete clocks CLK_{dis.}) The clocks are output according to the select signal CS and the primary calibration signal CRₚ generated by the advanced phase selector 64. The multiplexer 60 selects a selected clock CLK_{cs} from the discrete clock CLK₁₃₅, the interpolated clock CLK₁₅₀, the interpolated clock CLK₁₆₅, or the discrete clock CLK₁₈₀. And eventually, the selected clock CLK_{cs} output from the multiplexer 60 becomes a real-time clock CLKᵣₜ. The result of the real-time clock CLKᵣₜ triggering the input data DATAᵢₙ is recovery data DATA_{rd}.

Similarly, the phase detector 62 in the CDR 50 outputs signals relating to modifying the selected clock CLK_{cs} of the multiplexer 60 according to the phase difference between the selected clock CLK_{cs} and the input data DATAᵢₙ. In the present invention, the modified signal output by the phase detector 62 is an advanced calibration signal CRₐ.

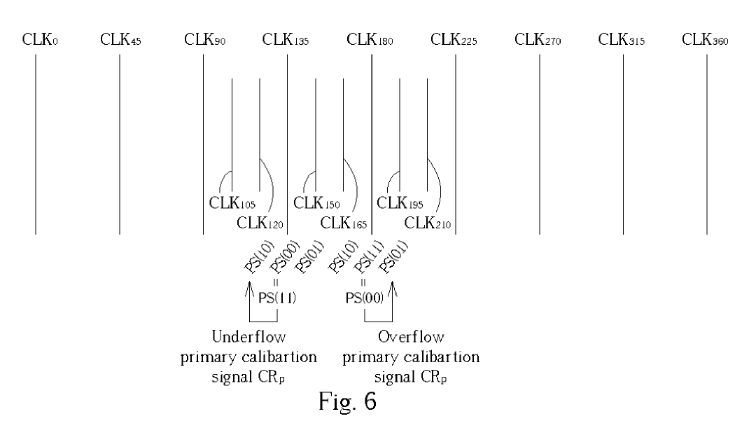

Please refer to FIG. 6 showing the variation of the phase select signal PS according to the present invention. Assume the predetermined value of the phase select signal PS is 10b. That is, the multiplexer 60 outputs a second leading discrete clock CLK_{dis} (CLK₁₆₅ in this case) from the four discrete clocks CLK₁₃₅, CLK₁₅₀, CLK₁₆₅, CLK₁₈₀ according to the phase select signal PS (10b). If the phase detector 62 detects that the discrete clock CLK₁₆₅ (i.e. the selected clock CLK_{cs}) lags behind the input data DATAᵢₙ, the phase detector 62 outputs the advanced calibration signal CRₐ to increment the phase select signal PS by one (the phase select signal PS is modified into 11b). In this way, the multiplexer 60 outputs the most leading discrete clock CLK_{dis} (CLK₁₈₀ in this case) from the four discrete clocks CLK₁₃₅, CLK₁₅₀, CLK₁₆₅, CLK₁₈₀. Assume the predetermined value of the phase select signal PS is 10b and the phase detector 62 detects that the discrete clock CLK₁₆₅ (i.e. the selected clock CLK_{cs}) leads the input data DATAᵢₙ. The phase detector 62 outputs the advanced calibration signal CRₐ to decrement the phase select signal PS by one (the phase select signal PS is modified into 01b). In this way, the multiplexer 60 outputs a third leading discrete clock CLK_{dis} (CLK₁₅₀ in this case) from the four discrete clocks CLK₁₃₅, CLK₁₅₀, CLK₁₆₅, CLK₁₈₀ instead.

If the phase select signal PS is already 11b (i.e. the value will overflow to 00b if 1 is added), and the phase detector 62 detects that the discrete clock CLK₁₈₀ (i.e. the selected clock CLK_{cs}) lags behind the input data DATAᵢₙ, since there is no discrete clock CLK_{dis} leading the discrete clock CLK₁₈₀ among the four discrete clocks CLK₁₃₅, CLK₁₅₀, CLK₁₆₅, CLK₁₈₀, the advanced phase selector 64 outputs the primary calibration signal CRₚ whenever the phase select signal PS overflows from 11b to 00b. The primary phase selector 58 outputs discrete clocks CLK₁₈₀, CLK₁₉₅, CLK₂₁₀, CLK₂₂₅ to the multiplexer 60 instead of the discrete clocks CLK₁₃₅, CLK₁₅₀, CLK₁₆₅, CLK₁₈₀. At this time, because the multiplexer 60 is required to output the discrete clocks CLK₁₉₅ (leading the discrete clock CLK₁₈₀), the phase select signal PS should be set to 01b, instead of rolling over from 11b to 00b. In other words, whenever the phase select signal PS overflows, the advanced phase selector 64 sets the phase select signal PS to 01b.

Conversely, if the phase select signal PS is 00b (i.e. the value will underflow if 1 is subtracted), and the phase detector 62 detects that the discrete clock CLK₁₃₅ (i.e. the selected clock CLK_{cs}) leads the input data DATAᵢₙ, since there is no discrete clock CLK_{dis} lagging behind the discrete clock CLK₁₃₅ among the four discrete clocks CLK₁₃₅, CLK₁₅₀, CLK₁₆₅, CLK₁₈₀, the advanced phase selector 64 outputs the primary calibration signal CRₚ whenever the phase select signal PS underflows from 00b to 11b. The primary phase selector 58 outputs discrete clocks CLK₉₀, CLK₁₀₅, CLK₁₂₀, CLK₁₃₅ to the multiplexer 60 instead of the discrete clocks CLK₁₃₅, CLK₁₅₀, CLK₁₆₅, CLK₁₈₀. Since at this time, the multiplexer 60 is required to output the discrete clocks CLK₁₂₀ (lagging behind the discrete clock CLK₁₃₅), the phase select signal PS should be set as 10b, instead of rolling over from 00b to 11b. In other words, whenever the phase select signal PS underflows, the advanced phase selector 64 sets the phase select signal PS as 10b. Of course, the overflow, underflow and reset operations described above can be also implemented in other manners.

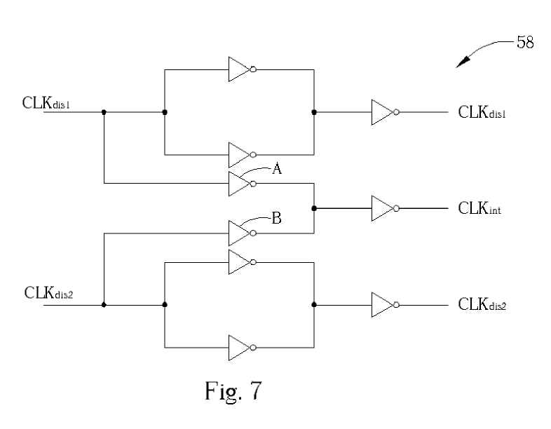

Please refer to FIG. 7 showing a circuit diagram of the primary phase selector 58 in the CDR. Two different discrete clocks CLK_{dis1}, CLK_{dis2} form the primary phase selector through a combination of a plurality of inverters. The width/length (W/L) of inverters A and B inside the combination can be properly controlled to obtain the required interpolated clock signal CLKᵢₙₜ. For example, the W/L can be expanded to obtain more interpolated clock signals CLKᵢₙₜ. Since many interpolated clock signals CLKᵢₙₜ can be produced, D flip-flops (or devices) for generating discrete clocks in the phase shifter 52 and for sampling discrete clocks in the data sampler 56 can be effectively reduced.

In contrast to the prior art, the CDR 50 according to the present invention includes the phase shifter 52 generating only 8 discrete clocks CLK₀-CLK₃₁₅, and the data sampler 56 including only 8 D flip-flops, thus the CDR 50 is smaller in size and consumes less power. Moreover, the primary phase selector 58 of the CDR 50 generates the plurality of interpolated clocks CLKᵢₙₜ based on the two consecutive discrete clocks CLK_{dis} generated by the phase shifter 52 as required, thus there is more elasticity on the CDR 50.

Those skilled in the art will readily observe that numerous modifications and alterations of the device may be made while retaining the teachings of the invention. Accordingly, the above disclosure should be construed as limited only by the metes and bounds of the appended claims.

1. A clock and data recovery circuit (CDR) generating a recovery clock according to an input data and a reference clock corresponding to the input data, the CDR comprising:
a phase shifter generating M discrete clocks at different phases according to the reference clock;
a data sampler generating a select signal according to the input data and the M discrete clocks;
a primary phase selector outputting two consecutive discrete clocks and at least one interpolated clock with a phase between the phases of the two consecutive discrete clocks, according to the select signal;
a multiplexer selecting one of the two consecutive discrete clocks or the interpolated clock to be a selected output clock;
a phase detector receiving the selected output clock to be the recovery clock, and outputting an advanced calibration signal if the recovery clock leads or lags the input data;
an advanced phase selector receiving the advanced calibration signal, and transmitting the phase select signal to the multiplexer for adjusting the selection of the selected clock, and a primary calibration signal to the primary phase selector for adjusting the two consecutive discrete clocks and at least one corresponding interpolated clock.

2. The CDR of claim 1, wherein the phase shifter is an analog phase-locked loop (APLL).

3. The CDR of claim 1, wherein the phase shifter is a delay-locked loop (DLL).

4. The CDR of claim 1, wherein the data sampler comprises M edge-triggered flip-flops, the input data is input to clock input ends of the M edge-triggered flip-flops, and the M discrete clocks are input to data input ends of the M edge-triggered flip-flops, respectively.

5. The CDR of claim 4, wherein the edge-triggered flip-flops are D flip-flops.

6. The CDR of claim 1, wherein the recovery clocks can be used to trigger the input data in order to generate a recovery data.

7. The CDR of claim 1, further comprising a counter connected between the data sampler and the phase detector for ensuring the stability of the input data and then inputting the input data to the data sampler.

8. The CDR of claim 1, wherein when the recovery clock lags the input data, the advanced calibration signal is output as plus 1, and when the recovery clock leads the input data, the advanced calibration signal is output as minus 1.

9. The CDR of claim 8, wherein the phase select signal of the advanced phase selector is modified according to the advanced calibration signal; and when both the two consecutive discrete clocks and the interpolated clock selected by the multiplexer according to the phase select signal lag or lead the input data, the advanced phase selector outputs the primary calibration signal.

10. The CDR of claim 8, wherein the primary phase selector is comprised of a plurality of inverters, and at least one interpolated clock can be formed by the two consecutive discrete clocks using inverters having different width/length (W/L) proportions.
